(19) United States
(12) Patent Application Publication
(10) Pub. No.: US 2005/0144320 A1
(43) Pub. Date: Jun. 30, 2005

(54) Avoiding conflict of a mobile node IP address

(76) Inventors: Venkata R. Jagana, Portland, OR (US); Krishna Kumar, Hillsboro, OR (US)

Correspondence Address: LIEBERMAN & BRANDSDORFER, LLC, 12221 MCDONALD CHAPEL DRIVE, GAITHERSBURG, MD, 20878, US

(21) Appl. No.: 10/737,673

(22) Filed: Dec. 16, 2003

(51) Int. Cl. G06F 15/16

(52) U.S. Cl. 709/245

(57) ABSTRACT

A method and system for effectively resolving a conflict of an internet protocol address of a mobile node. The system includes a home agent registration table that maintains a listing of a portion of binding registration data associated with the mobile node as it may move to different networks. The home agent registration table is preferably maintained in non-volatile memory. Following a termination of the mobile node, the home agent registration table is consulted. If the mobile node was properly terminated, all address registrations stored with the home agent registration table will have been removed. However, if the mobile node was improperly terminated, all address registrations stored with the home agent registration table will be removed prior to assignment of a new home internet protocol address.

### BACKGROUND OF THE INVENTION

1. Technical Field

This invention relates to mobile computing device technology. More specifically, the invention relates to resolving conflicts with an internet protocol address for a mobile computing device.

2. Description of the Prior Art

IPv6 is the successor protocol standard from IPv4. The IPv6 protocol offers expanded addressing capability to allow any computing device to obtain a unique address when connected to a global network, i.e. a set of interconnected networks. A computing device on the global network may be a stationary or mobile computing device with a communication port, and is referred to as a mobile node. The computing device may support wired or wireless communication. Each computing device operating within Mobile IPv6 is assigned an internet protocol address, also known as a home address to identify the computing device as it may move to different physical locations across the global network.

FIG. 1 is a block diagram (10) of a mobile node (12) in communication with a router (14) through a first connection (18) to a network (5), also known as the home location. The home location is a permanent address of the mobile node. In addition to the mobile node (12), there is a correspondent computing device (16), which is also in communication with the router (14) through a second connection (20) to foreign network (6). The correspondent computing device (16) is a peer node with which the mobile node (12) is communicating. The router functions as the home agent for the mobile node (12). A home agent is a network node that assists with home services to the mobile node after it moves to a foreign location, i.e. a connection to the network other than it's previous connection. Home services may include assisting with finding the current location of the mobile node, and forwarding data packets to the mobile node at a foreign location. Communication packets between the mobile node (12) and the correspondent computing device (16) are processed through the router (14). The mobile node (12) has the ability to move to different locations while maintaining connection with the network (5) and communication with the router (14). FIG. 2 is a block diagram (30) showing the mobile node (12) and the correspondent computing device (16), also known as a correspondent node, in communication with the router (14) through a second connection (20) to foreign network (6). The mobile node is shown moved from a home location (12) to another location (32), also known as a foreign location relative to the home location. The mobile node (12) may continue to communicate with the correspondent computing device (16) through the second connection (34) while connected to the network at the foreign location (32). While the mobile node (12) is away from its home location, the home agent (14) intercepts packets on the home connection (18) destined to the mobile node's home address, and tunnels them to the mobile node's foreign location (32). Accordingly, the mobile node has the ability to move to different locations across a global network and either to continue or to establish communication with other computing devices.

Although FIG. 2 shows one mobile node at the home location, the illustration may be expanded to show a plurality of nodes at the home network location, wherein the network (5) is the home network. The correspondent node (16) may also be on the home network (5). Each node in the home network maintains a mapping of all node IP addresses with the associated physical hardware address for each node with which it maintains communication. The mapping is stored in local memory of the node. The mapping of the IP address with the physical hardware address is also known as the neighbor discovery cache. At such time as the mobile node may move away from the home location, the home agent on the network will send a message to all other nodes on the home network specifying the association of the home address of the mobile node with the hardware address of the home agent. This process enables the home agent to receive data packets addressed to the mobile node. Accordingly, the neighbor discovery cache maintains the mapping of IP address and physical hardware address of all nodes in the home network.

Currently, when the mobile node is properly started at its home location on a network, it receives a home internet protocol address. At some point in time subsequent to the initial start at the home location, the mobile node may move to a foreign location within the network. Subsequent to arrival at the foreign location, the mobile node receives a temporary address known as a care of address (CoA). The CoA address is a routable address with a mobile node while the mobile node is visiting a foreign location, and is valid as long as the mobile node is at the specified foreign location. Upon receipt of the CoA, the mobile node forms a binding or an association between the home address and the CoA and registers the binding with the home agent residing in the home network. A binding registration contains information including: sequence number, acknowledgment bit, home registration bit, lifetime, home agent address, and mobile node home address. The binding is the formation of an association between the home address and the CoA, and is valid for a defined period of time. The binding itself contains only home addresses and CoAs. This process is known in the art as Primary Care of Address Registration. The binding enables the mobile node to receive all packets addressed to it's home internet protocol address. Following the binding process all data packets are now tunneled to the mobile node's new location by the home agent. In addition, the mobile node may also send a binding update to a correspondent computing node either upon receiving a data packet from the home agent or upon sending an outgoing packet from the foreign location to the correspondent computing node. The binding update enables subsequent direct flow of data packets between the mobile node and the correspondent node without tunneling through the home agent. Every binding update sent by the mobile node to any computing device on the network will be saved in a binding update list in local cache of memory of the mobile node for future updates by the mobile node. A binding update to the home agent is marked with a home registration flag and is therefore distinguished from the binding updates sent to a correspondent node. At such time as the mobile node returns to it's home location, the mobile node will de-register the corresponding binding for it's home address or CoA with the home agent and also with the correspondent node. Accordingly, the binding process enables the mobile node to move to foreign locations within the network while continuing to receive data packets.

While the mobile node is present in the foreign location, i.e. following the binding process, the mobile node may experience an improper shut down. If the operator of the mobile node intends to restart the mobile node at the home location, a failure of the reuse of the home IP address of the mobile node will occur. However, if the operator intends to restart the mobile node at a foreign location the mobile node will be configured with a new CoA and register the new CoA with the home agent. During a subsequent communication, the home agent may receive a data packet for the mobile node on the original home internet protocol address. The home agent will tunnel the data packet to the mobile node registered with the original CoA address. Since the mobile node was restarted subsequent to an improper shut down, the home agent is not aware of the relationship between the former CoA address and the new internet protocol address of the mobile node. Therefore, the data packets are not forwarded to the mobile node at it's new internet protocol address. Accordingly, there is no structure within the communication protocol of IPv6 to ensure that the mobile node will receive all data packets addressed to it after a restart of the mobile node that was subject to an improper shut down.

There is therefore a need for a method and system to enable continued communication of data packets with a mobile node restarted subsequent to an improper shut down.

### SUMMARY OF THE INVENTION

This invention comprises a method and system to resolve conflict of an internet protocol address of a mobile node.

In one aspect of the invention, a method is provided for avoiding conflict of an internet protocol home address of a mobile node. A portion of binding registration data of the mobile node is stored in a home address registration table. The home address registration table is reviewed subsequent to a shut down of the mobile node.

In another aspect of the invention, a communication system is provided with a mobile node having an associated internet protocol home address. A storage manager is provided to store a portion of binding registration data of the mobile node in a home address registration table. In addition, a control manager is provided to review the home address registration table after shut down of the mobile node.

In yet another aspect of the invention, an article is provided with a computer-readable signal bearing medium. Means in the medium are provided for storing a portion of binding registration data of a mobile node in a home address registration table. In addition, means in the medium are provided for reviewing the home registration table subsequent to shut down of the mobile node.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a prior art block diagram of a mobile node in communication with a router from a home location.

FIG. 2 is a prior art block diagram of a mobile node in communication with a router from a foreign location.

FIG. 3 is a flow chart of a mobile node operating under IPv6 according to the preferred embodiment of this invention, and is suggested for printing on the first page of the issued patent.

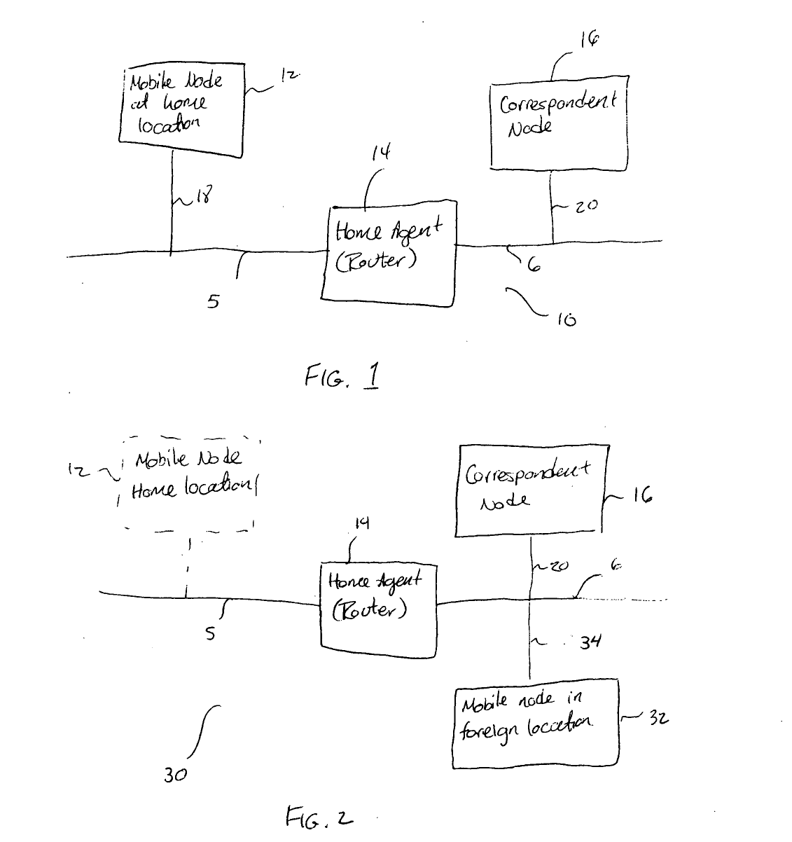

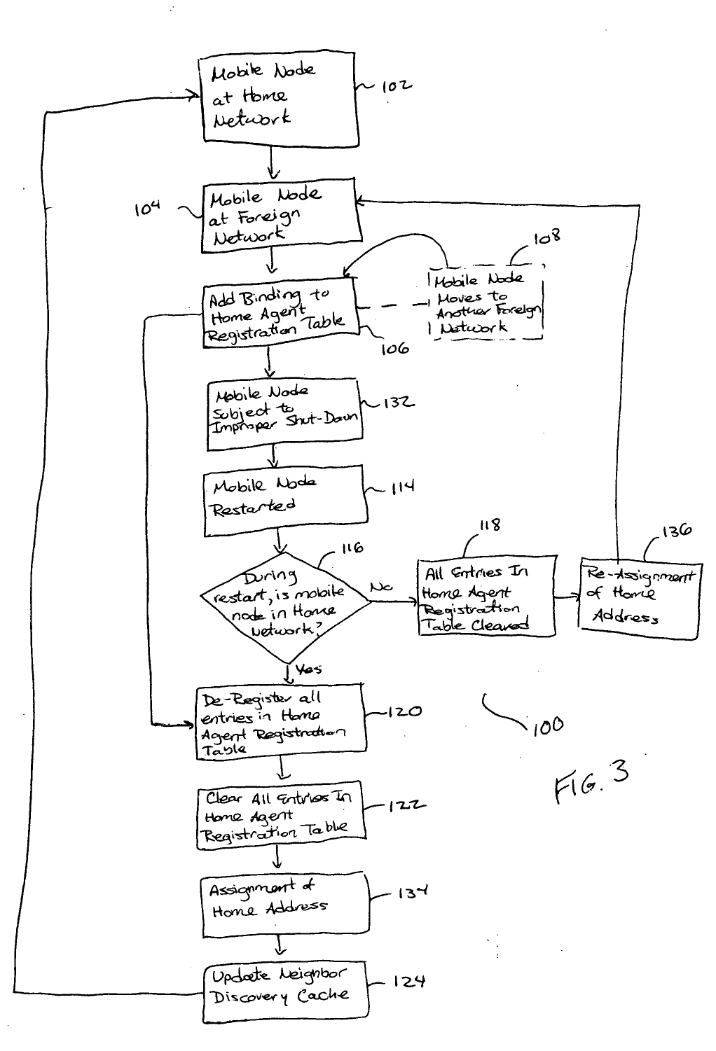

### DESCRIPTION OF THE PREFERRED EMBODIMENT

### Overview

A home agent registration table is maintained in a non-volatile storage of the mobile node. The registration table stores a portion of binding registration data of the mobile node as it moves to one or more foreign locations within the network. Subsequent to a termination of operation of the mobile node, the home registration table is reviewed. If the termination of operation of the mobile node was proper and the mobile node was terminated at the home location, the home registration table will be empty. Alternatively, if the termination of the mobile node was proper and the mobile node was terminated at a foreign location, all entries in the home agent registration table will be removed. However, if termination of the mobile node was improper either at the home location or at a foreign location, all entries in the home agent registration table will be de-registered and/or cleared at such time as the mobile node is subject to a restart and prior to assignment or re-assignment of its home address. The de-registration and/or clearing of entries in the home agent registration table prevents forwarding of data to an invalid address. Accordingly, the home agent registration table in conjunction with the associated logic ensures an accurate and current log of all registrations associated with the mobile node by keeping the log of registrations current.

### Technical Details

In a preferred embodiment, a home agent registration table is provided in non-volatile storage of local storage media of a mobile node. The home agent registration table maintains a history of all active home agent registrations made by a mobile node during its various movements in both a home network and foreign networks. The home agent registration table stores only a select portion of the binding data. The elements present in the home agent registration table include: the sequence number used in the binding update, the home agent address used in the binding update, and the mobile node's home address used in the binding update.

FIG. 3 is a flow chart (100) illustrating the process of preserving a mobile node address for a mobile node to enable continued communication with the mobile node following a proper or improper shut down of the mobile node. If the mobile node is starting in the home network following a proper shutdown, or if the mobile node did not visit any foreign networks prior to a previous shut down, the home agent registration table will be empty. When a mobile node is started, whether in a home network or a foreign network, it loads the home agent registration table from non-volatile storage (102) to volatile memory. If the mobile node has not visited any foreign networks prior to an improper shutdown, the home agent registration table will be empty. The mobile node is shown moving to a foreign network (104). At such time as the mobile node moves to the foreign network (104), an entry of the CoA is added to the home agent registration table stored in non-volatile memory (106). The entry in the home agent registration table includes the following three fields: sequence number field, home agent address field, and home address field. A sequence number of the current home registration request packet is maintained in the sequence number field, a destination address of the current home registration request packet is maintained in the home agent address field, and the value of the home address destination option is maintained in the home address field. The mobile node may move to another foreign network where it would receive another CoA (108). This would cause a second registration to be placed in the home agent registration table in conjunction with receiving the new CoA. In the first registration, the sequence field of the home registration entry in the home agent registration table is modified to the new sequence number of the registration request packet. In the second registration, a new entry is created in the home agent registration table including the sequence number, the destination address, and the value of the home address destination option. The CoA address for the mobile node is valid as long as the mobile node is present on the foreign network. Accordingly, new entries associated with foreign registration of the mobile node are added to the home agent registration table as they occur.

Similarly, once the mobile node is in the foreign network, it may return to the home network. A de-registration of all entries in the home agent registration table will occur (120) in the form of a de-registration of all entries in the home agent registration table. The de-registration process includes a message sent to the corresponding home agent indicating the earlier registration identified by the home address and CoA should be de-registered from the home agent registration table. Following the de-registration process, all entries from the home agent registration table are removed (122) and the mobile node is assigned a home address (134). Thereafter, the neighbor discovery cache entry of all nodes in communication with the mobile node is updated with a hardware address of the mobile node (124). Accordingly, at such time as the mobile node returns to the home network from a foreign network, all entries in the home agent registration table are de-registered prior to removal from the table.

Following the period in which the mobile node has been in operation in the home network or a foreign network, the mobile node may experience an improper shut down (112). The improper shut down may happen at any time. An improper shut down may include a sudden loss of power to the mobile node. Hereinafter, a loss of power will be used as an example of an improper shut down. Thereafter, the mobile node is restarted (114). At such time as power is return to the mobile node, a test is conducted to determine if the mobile node has returned to the home network (116). A negative response to the test at step (116), is an indication that the mobile node has been restarted in a foreign network location. The home agent registration table is reviewed to determine if there are any entries in the table. All entries for the CoA(s) for the mobile node in the home agent registration table are removed (118), followed by re-assignment of the home address to the mobile node (136). The mobile node then return to step (104) and receives a temporary address known as a Care of Address (CoA) in the foreign network, and an entry of the CoA is added to the home agent registration table stored in non-volatile memory (106). This information is maintained in preparation for the next shut down event of the mobile node. By tracking addresses of the mobile node as it moves to different locations in the network, the home address may be re-used following an improper shut down and a restart of the mobile node in a foreign network. Following a positive response to the test at step (116), the home agent registration table will be reviewed prior to a de-registration of all entries with the home agent registration table (120). Thereafter, all entries from the home agent registration table are removed (122), the mobile node is assigned a home address (134), and the neighbor discovery cache entry of all nodes in communication with the mobile node is updated with a hardware address of the mobile node (124). Accordingly, entries for CoA addresses for the mobile node in the home agent registration table must be properly maintained in order to preserve proper communication with the mobile node following proper or improper shutdown of the mobile node in either the home network or a foreign network.

### Advantages Over The Prior Art

The maintenance of the home agent registration table ensures a current listing of all addresses associated with a mobile node in a global communication network. The home agent registration table is located in non-volatile memory. As noted above, the home agent registration does not require use of the entire binding data to be stored therein. Rather, the home agent registration table only saves a portion of the binding data required to de-register with the home agents for proper reuse of the home address in case of an improper shut down. It is the placement of the home agent registration table and the associated registrations and removal of addresses associated with either proper or improper shut downs of a computing device that enables the accurate addressing of data packets across the network. Accordingly, whether the mobile node experiences a proper or improper shut down in either a home location or a foreign location, data packets will be accurately tunneled to the mobile node at such time as the mobile node is restarted at any location in the network.

### Alternative Embodiments

It will be appreciated that, although specific embodiments of the invention have been described herein for purposes of illustration, various modifications may be made without departing from the spirit and scope of the invention. In particular, the invention may be expanded to an operating scenario that is supported by the infrastructure associated with the home agent registration table under which the network connection has multiple home agents, a mobile node has multiple home addresses on the home connection to the network, and the mobile node obtains multiple CoAs when it moves to a foreign network connection. Additionally, the network may be a local area network, a global area network, or any network that supports IPv6. Accordingly, the scope of protection of this invention is limited only by the following claims and their equivalents.

1. A method for avoiding conflict of an internet protocol home address of a mobile node comprising:
(a) storing a portion of binding registration data of said mobile node in a home address registration table; and
(b) reviewing said registration table subsequent to a shut down of said mobile node.

2. The method of claim 1, further comprising returning an empty registration table following a proper shut down of said mobile node.

3. The method of claim 1, further comprising removing all entries in said registration table during restart of said mobile node at a foreign location following an improper shut down of said mobile node.

4. The method of claim 1, further comprising de-registering all entries in the home agent registration table during restart of said mobile node at a home location following an improper shut down of said mobile node and prior to removing said entries from said table.

5. The method of claim 4, further comprising deferring assignment of a home address to said mobile node until completion of said removal.

6. The method of claim 5, further comprising replacing a neighbor discovery cache entry of all nodes in communication with said mobile node with a hardware address of said mobile node.

7. The method of claim 1, wherein said portion of binding registration data is selected from a group consisting of: a sequence number of the current home registration request packet, a destination address of the current home registration request packet, and the value of the home address destination.

8. A communication system comprising:
a storage manager to store a portion of binding registration data of said mobile node in a home address registration table; and
a control manager to review said registration table after shut down of said mobile node.

9. The system of claim 8, further comprising a return of an empty registration table after a proper shut down of said mobile node.

10. The system of claim 8, further comprising a removal of all entries in said registration table during a restart of said mobile node at a foreign location and subsequent to an improper shut down of said mobile node.

11. The system of claim 8, further comprising a de-registration of all entries in the home agent registration table during restart of said mobile node at a home location following an improper shut down of said mobile node and prior to a removal of said entries from said table.

12. The system of claim 11, further comprising a deferment of an assignment of a home address to said mobile node until completion of said removal.

13. The system of claim 12, further comprising a neighbor manager to replace said neighbor discovery cache entry of all nodes in communication with said mobile node with a hardware address of said mobile node.

14. The system of claim 8, wherein said portion of binding registration data is selected from a group consisting of: a sequence number of the current home registration request packet, a destination address of the current home registration request packet, and the value of the home address destination.

15. An article comprising:
a computer-readable signal-bearing medium;
means in the medium for storing a portion of binding registration data of a mobile node in a home address registration table in persistent storage; and
means in the medium for reviewing said registration table subsequent to shut down of said mobile node.

15. The article of claim 14, wherein the medium is selected from a group consisting of: a recordable data storage medium and a modulated carrier signal.

16. The article of claim 14, further comprising means in the medium for returning an empty home address registration table following a proper shut down of said mobile node.

17. The article of claim 16, further comprising means in the medium for removal of all entries in said registration table during a restart of said mobile node at a foreign location and subsequent to an improper shut down of said mobile node.

18. The article of claim 16, further comprising means in the medium for de-registering all entries in said home agent registration table during restart of said mobile node at a home location following an improper shut down of said mobile node and prior to removal of said entries from said table.

19. The article of claim 18, further comprising means in the medium for deferring assignment of a home address to said mobile node until completion of said removal.

20. The article of claim 19, further comprising means in the medium for replacing a neighbor discovery cache entry of all nodes in communication with said mobile node with a hardware address of said mobile node.
